(19) United States
(12) Patent Application Publication
(10) Pub. No.: US 2007/0039554 A1
(43) Pub. Date: Feb. 22, 2007

(54) Basin nectar bird feeder with improved stability

(76) Inventor: Barry D. Colvin, Bristol, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/205,266

(22) Filed: Aug. 16, 2005

(51) Int. Cl. A01K 7/00

(52) U.S. Cl. 119/72

(57) ABSTRACT

The nectar bird feeder, which has improved stabilization, includes a base with a bottom surface, a central portion, and a trough-shaped reservoir positioned about the central portion for containing nectar therein. A hanger is connected to the central portion of the base and extends upwardly therefrom. An extension stabilizing member is connected to the base and downwardly depends therefrom, such as from the bottom surface of the base. An annular-shaped cover, having a top surface and lower edges, is releasably attached to the base and co-extensive with the trough of the base with an aperture therein. The center of gravity of the feeder, with the stabilizing member, is located below the bottom surface of the base for improved stabilization thereof during filling and use of the feeder.

### BACKGROUND OF THE INVENTION

This invention relates generally to animal feeders and, in particular, bird feeders. More specifically, the present invention relates to bird feeders of the nectar feed type, such as hummingbird, oriole and butterfly bird feeders and methods of stabilizing and filling such feeders.

Nectar bird feeders are available in three basic designs. The basin or saucer-type feeder is exemplified in the Kilham U.S. Pat. No. 3,913,527, the basin bottle is exemplified by the Williams U.S. Pat. No. 3,292,589, and the tube bottle feeder is exemplified by the Fowler U.S. Pat. Number 3,125,069. The tube bottle has certain disadvantages as it is hard to clean, tends to drip in warm weather and is messy to refill, particularly if it is not completely empty. The basin bottle holds more liquid than a straight basin feeder but it too drips due to the downward pressure of the nectar and if jarred by the wind or larger birds. Also, basin bottle feeders are also very messy to refill.

The basin feeder is a vast improvement and as it holds the nectar out of reach of most insects and larger birds, is much easier to clean than other types of nectar feeders and does not leak. It is sometimes thought that its small capacity is a disadvantage because of its typical capacity in the range of 8-16 ounces. However, less nectar in the feeder can be an advantage because the possibility of dangerous nectar fermentation and mold formation after a couple of days is reduced thereby preventing harm to butterflies, hummingbirds and orioles.

In view of the foregoing, the basin type feeder has many advantages over other types of feeders. However, the saucer shape has a larger surface area than other nectar feeders because it must also hold the nectar therein. As a result, the basin feeder is more likely to move about from the effects of weather, particularly, wind. This can cause the nectar to spill and splash out of the feed ports causing undesirable results. This instability is also possible when the feeder is being filled outside in certain weather conditions.

Further details of a prior art basin type feeder is shown and described below in connection with FIG. 1. A typical prior art basin nectar feeder 10 includes a saucer-shaped base 12 that includes flat bottom surface 14 that serves as a floor for a reservoir trough 16 that is typically annular-shaped. A hanger 18 is typically connected, which can be removably connected, to a center area 20 in the middle of the ring-shaped reservoir 16. A cover 22 includes a center aperture 24 so that it can be easily placed over the hanger 18 into releasable engagement with the top open end 26 of the reservoir trough 16 of the base 12. Typically, the cover 22 is frictionally engaged with the base 12 so it can be easily removed when desired.

The cover 22 includes a number of feed ports 28 about the periphery thereof to permit a bird, such as a hummingbird, to access the nectar feed 30 therethrough. The feed ports 28 are commonly configured to appear as flowers and the cover 22 is typically of different colors depending on which type of birds are to be attracted to the feeder 10. Such configuration can be modified to attract different types of birds, as desired.

As can be understood, when the nectar 30 within the feeder 10 has been consumed, it must be re-filled so that more birds can feed. In accordance with the prior art feeder 10 of FIG. 1, the feeder 10 must be first placed on a support surface 32 with the flat bottom surface 14 of the base 12 in communication with the support surface 32, which can be a table, for example. The cover 22 is then typically removed from the base 12 and routed over the hanger 18 to reveal the annular-shaped nectar feed trough 16. The hanger 18 can be removed before removal of the cover 22, if desired. Further details of the prior art feeder 10 of FIG. 1 need not be provided as this construction is well-know in the art.

Once the nectar feed trough 16 is exposed, nectar feed 30 can be poured therein in the amount desired, all while the base 12 of the feeder is lying flat on a support surface 32. When the feed trough 16 is preferably filled, the cover 22 is attached back onto the base 12. The cover 22 is routed over the hanger 18 if the hanger 18 was left connected to the base 12 or attached directly to the base 12 after which the hanger 18 can be re-attached. The entire feeder 10 can now be hung from a tree or post (not shown) via the hook 18a.

Prior art basin type nectar bird feeders 10 can be easily filled because the bottom surface 14 of the base 12 is substantially flat which enables it to be placed level on a support surface 32. However, as stated above, the flat saucer shape of the feeder of FIG. 1 acts as a wind foil and can easily become unstable during windy weather or when numerous birds are feeding at the same time.

Also, the feeder 10 can be filled while it is hanging from a support. The cover 22 can be removed and then the nectar can be poured into the base 102. However, wind and other environmental conditions can de-stabilize the feeder 10 during the filling process.

Therefore, the prior art basin type nectar feeders, while they are highly desirable for their cleanliness compared to other types of feeders and are attractive in appearance, they suffer from the disadvantages of being unstable in certain conditions. Therefore, there is a need for a basin type nectar bird feeder that is extremely stable, even during adverse weather conditions. There is further need for a basin type nectar bird feeder that is stable during filling with little or no mess. There is yet a further need for a basin type nectar bird feeder that the stabilizing member can also be ornamental to improve the overall performance, appearance and enjoyment of the feeder.

### SUMMARY OF THE INVENTION

The present invention preserves the advantages of prior art bird feeders and structures and configurations used to stabilize them. In addition, it provides new advantages not found in currently available feeders and stabilization structures and overcomes many disadvantages of such currently available feeders and stabilization configurations.

The invention is generally directed to a novel and unique basin nectar bird feeder that has improved stabilization over prior art basin feeders.

The basin nectar bird feeder, which has improved stabilization, includes a base with a bottom surface, a central portion, and a trough-shaped reservoir positioned about the central portion for containing nectar therein. A hanger is connected to the central portion of the base and extends upwardly therefrom. An extension stabilizing member is connected to the base and downwardly depends therefrom, such as from the bottom surface of the base. An annular-shaped cover, having a top surface and lower edges, is releasably attached to the base and co-extensive with the trough of the base with an aperture therein. The center of gravity of the feeder, with the stabilizing member, is located below the bottom surface of the base for improved stabilization thereof during filling and use of the feeder.

It is therefore an object of the present invention to provide a basin nectar bird feeder that is more stable than prior art basin nectar bird feeders.

It is an object of the present invention to provide a basin nectar bird feeder that is stable during filling.

It is a further object of the present invention to provide a basin nectar bird feeder that is stable during feeding.

It is a yet further object of the present invention to provide a basin nectar bird feeder that is less susceptible to spilling in adverse weather conditions than prior art basin nectar bird feeders.

Another object of the present invention is to provide a basin nectar bird feeder that is more stabile during filling to reduce mess and cleanup and to facilitate such filling.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a front perspective view of a prior art basin nectar feeder;

FIG. 2 is a top perspective view of a basin nectar bird feeder of the present invention;

FIG. 3 is a bottom perspective view of the basin nectar bird feeder of FIG. 2;

FIG. 4 is a side elevational view of the basin nectar feeder of FIG. 2;

FIG. 5 is a top view of the feeder of FIG. 2;

FIG. 6 is a bottom view of the feeder of FIG. 2;

FIG. 7 is a first alternative embodiment of the basin nectar bird feeder in accordance with the present invention;

FIG. 8 is second alternative embodiment of the basin nectar bird feeder in accordance with the present invention;

FIG. 9 is third alternative embodiment of the basin nectar bird feeder in accordance with the present invention; and

FIG. 10 is fourth alternative embodiment of the basin nectar bird feeder in accordance with the present invention.

### DETAILED DESCRIPTION OF THE PREFERRED EMBODIMENT

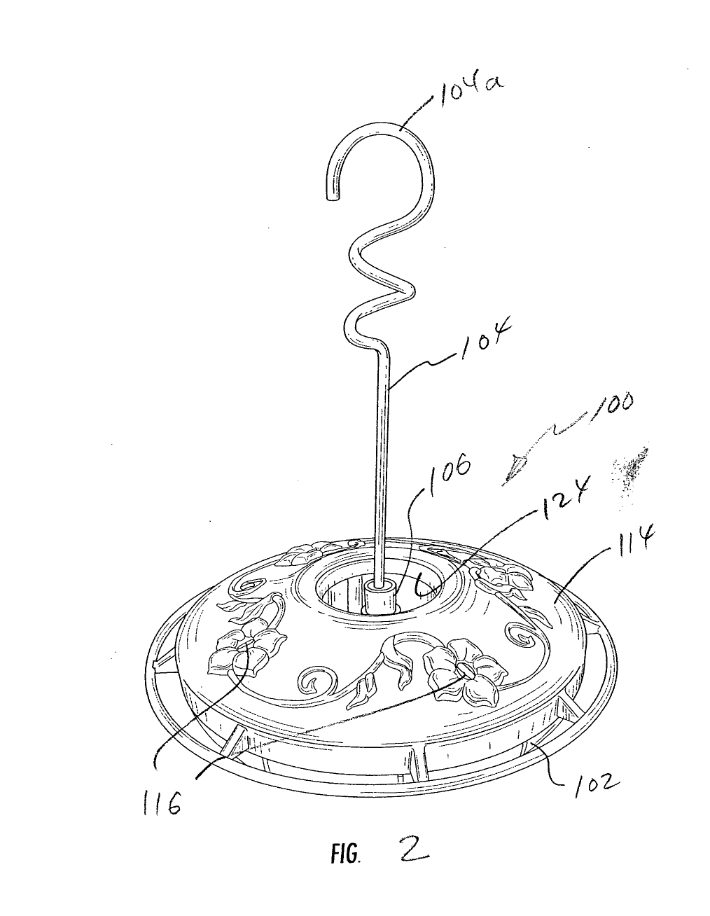

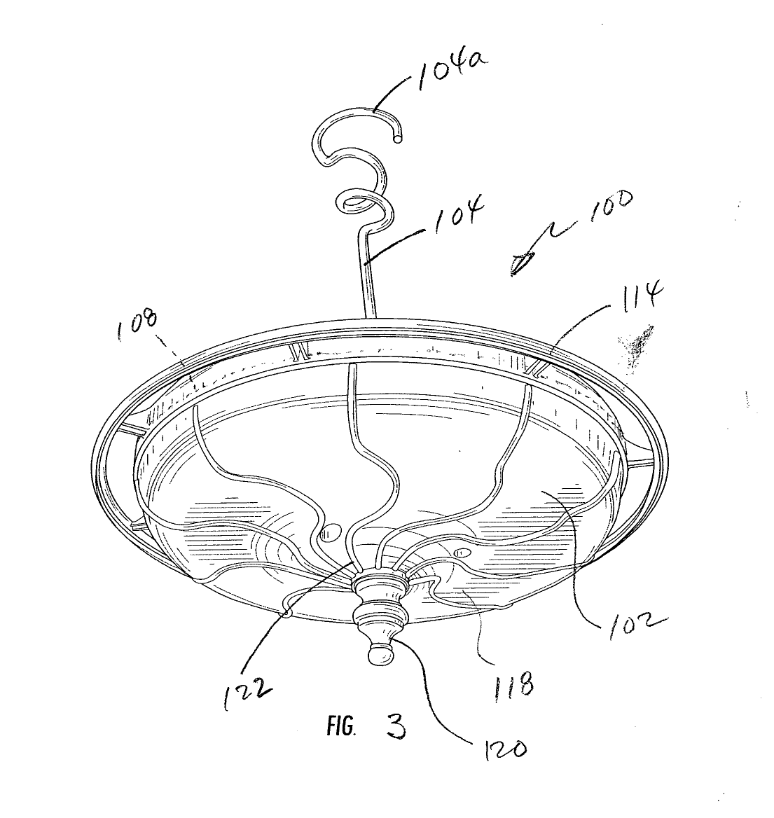

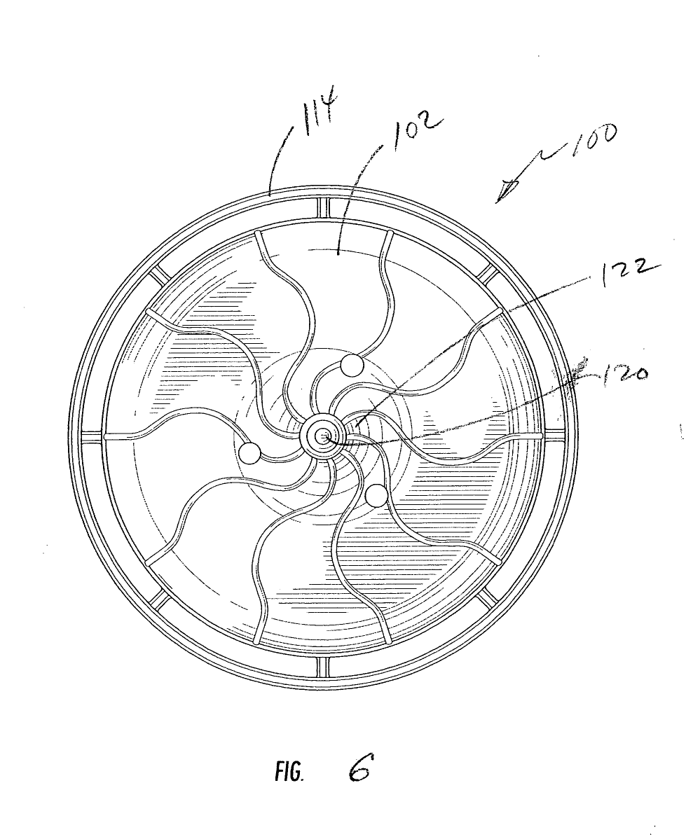

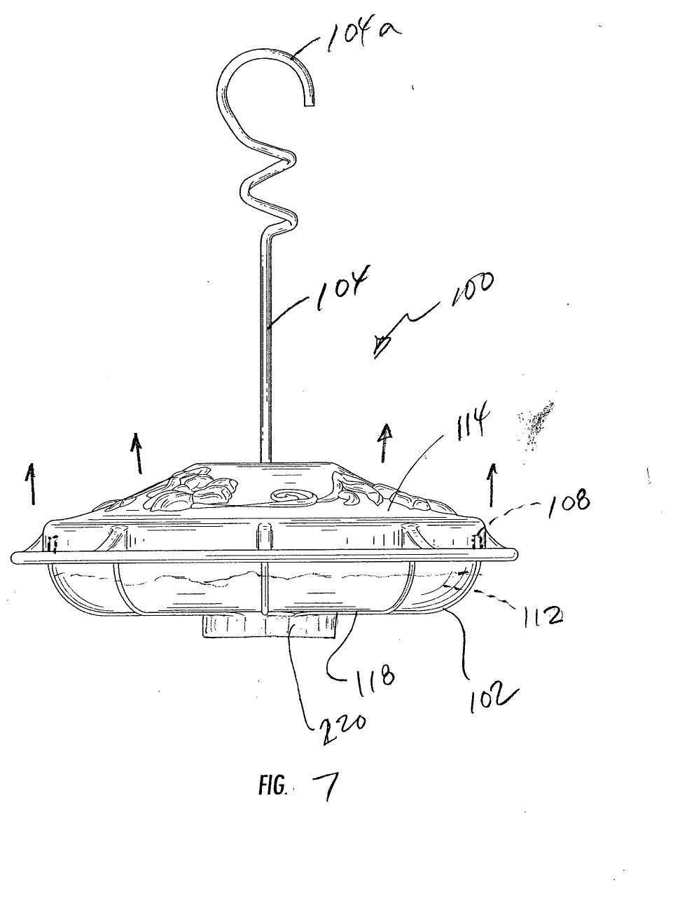

In FIGS. 2-6, the bird feeder 100 of the present invention is shown. The feeder 100 includes a base 102 with a hanger 104 detachably connected to a central region 106 thereof. For example, the hanger 104 can be threadably secured to the base 102. The base 102 includes a top open end 108 to form an annular-shaped trough 110, as best seen in FIGS. 7-9, for containing nectar feed 112.

A cover 114 is releasably secured to the base 102 at its top open end 108 to cover the trough 110 and protect the nectar feed 112 contained therein. A number of feed ports 116 are provided through the cover 114 to permit access to the nectar feed by the appropriate birds, such as hummingbird, orioles and butterflies, for example. The feed ports 116 are preferably configured to appear as flowers, or other structures, to further attract birds to the feeder 100. Further, the cover 114 can be of different colors, such as red, to attract the desired type of bird. As can be understood, the feed ports 116 are positioned over the nectar trough 110 so that feeding birds are aligned thereover for optimum access to the nectar 112 therein.

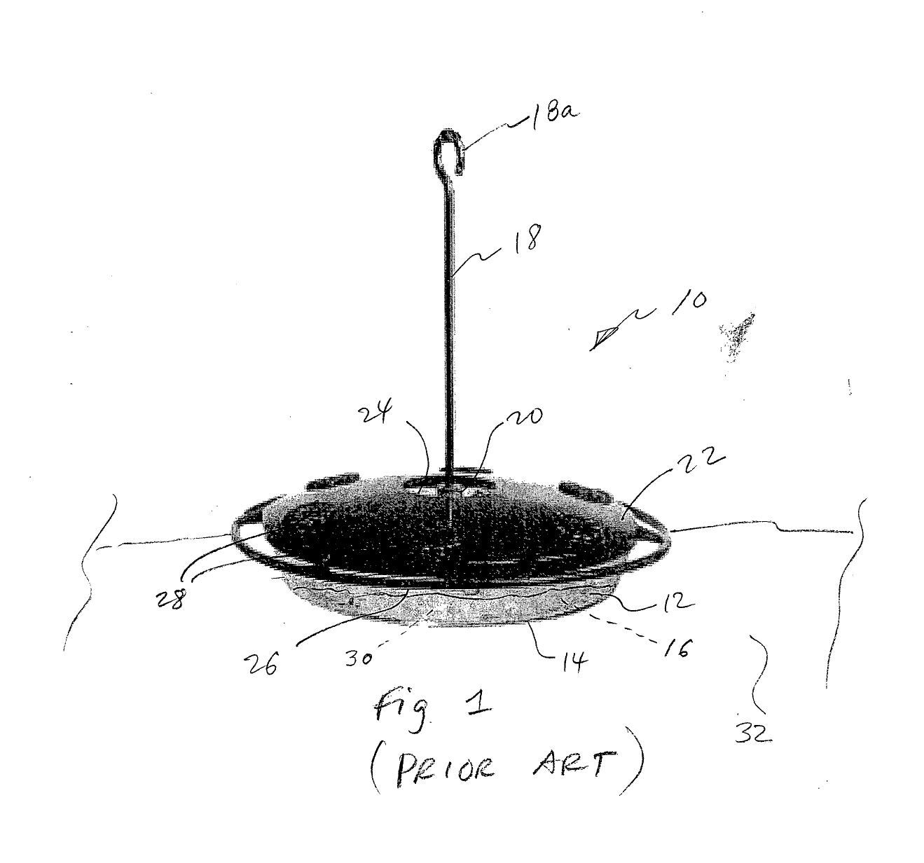

The feeder 100 of FIGS. 2-6 is unique in that, unlike the prior art feeder of FIG. 1, the bottom surface, generally referred to as 118, of the base 102 includes, for example, a downwardly depending structure, generally referred to as 120, and, optionally, a sloped portion 122. The downwardly depending structure 120 is a stabilizing member in accordance with the present invention. The stabilizing member 120 can also be decorated so it may serve as an ornamental member to provide additional aesthetic appeal of the feeder 100 while it is stabilizing the feeder.

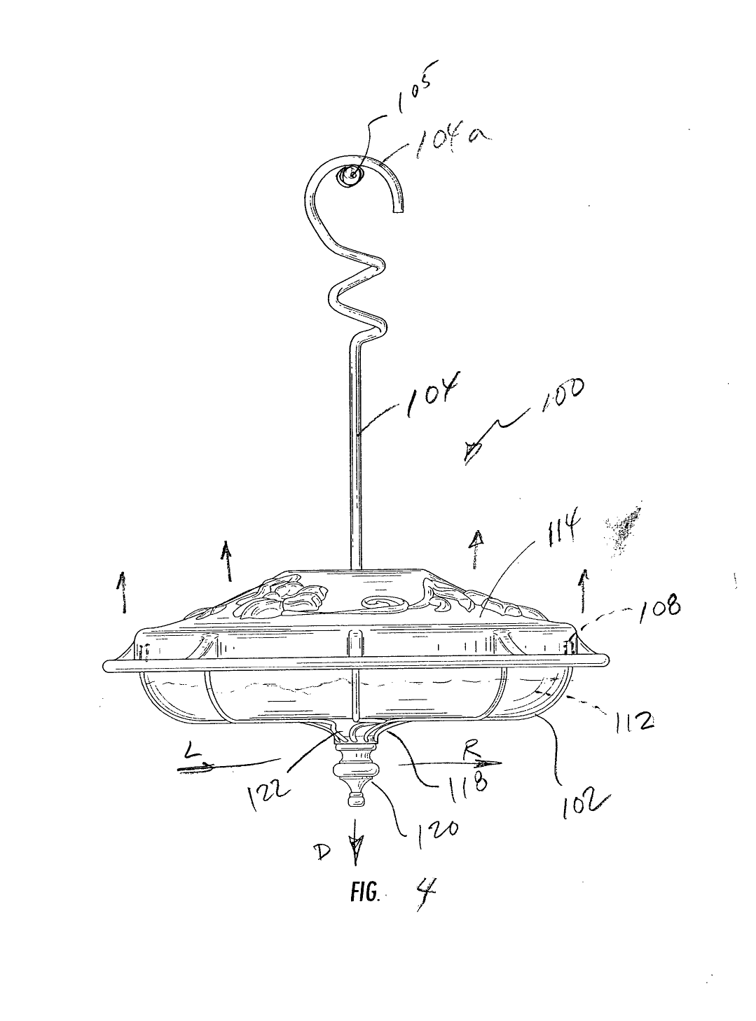

As best seen in FIG. 4, the stabilizing member 120 member serves as an additional centering weight below the bottom surface 118 of the feeder 100 to lower the overall center of gravity of the enter feeder to make it more stable in adverse weather, such as windy conditions, for example. Also, the lower center of gravity makes the overall handling of the feeder more stable, such as during filling of the feeder.

More specifically, the stabilizing member 120 provides a downward force as represented by arrow referenced as D, as seen in FIG. 4, which lowers the center of gravity and makes the overall length of the feeder longer, from hook portion 104a of the hanger 104 to the bottom of the stabilizing member, thereby making the moment arm formed from support member 105, which could be a support post, longer thereby requiring more force to rock the feeder laterally left and right as indicated by arrows referenced as L and R.

The lower center of gravity of the feeder 100 helps to prevent the liquid nectar from undesirably splashing around inside the feeder 100. The member 120 can serve a dual purpose and be aesthetically appealing as well. Furthermore, the bottom surface 118 of the base can be contoured, with sloped side walls 118, to add further aesthetic appeal to the feeder 100. In general, this unique feeder 100 of the present invention includes a base 102 that is equipped with a stabilizing weight member 120.

The stabilizing member 120, in FIG. 4, preferably has the ornamental appearance of a finial-like member with appealing contours thereon. The weight of the stabilizing member 120, regardless of its ornamentality, provides the desired stabilizing affect. For example, the stabilizing member preferably weighs in the range of 5 to 32 ounces but could be lower or higher depending on the size and configuration of the feeder 100. The stabilizing member can be made of any heavy material, such as metals including brass, aluminum and steel. The finial style configuration of the stabilizing member 120 of the feeder 100 of FIGS. 2-6 is just one of many different configurations that can be employed in accordance with the present invention. Many different types of ornamental configurations can be employed and still be within the scope of the present invention.

Referring now to FIGS. 7-10, alternative embodiments of the present invention is shown. In FIG. 7, the stabilizing member 220 is provided in the configuration of a disk that could be made of metal, for example. The disk 220 is relatively low profile yet still provides the added weight below the bottom surface 118 of the base to improve stabilization of the feeder 100.

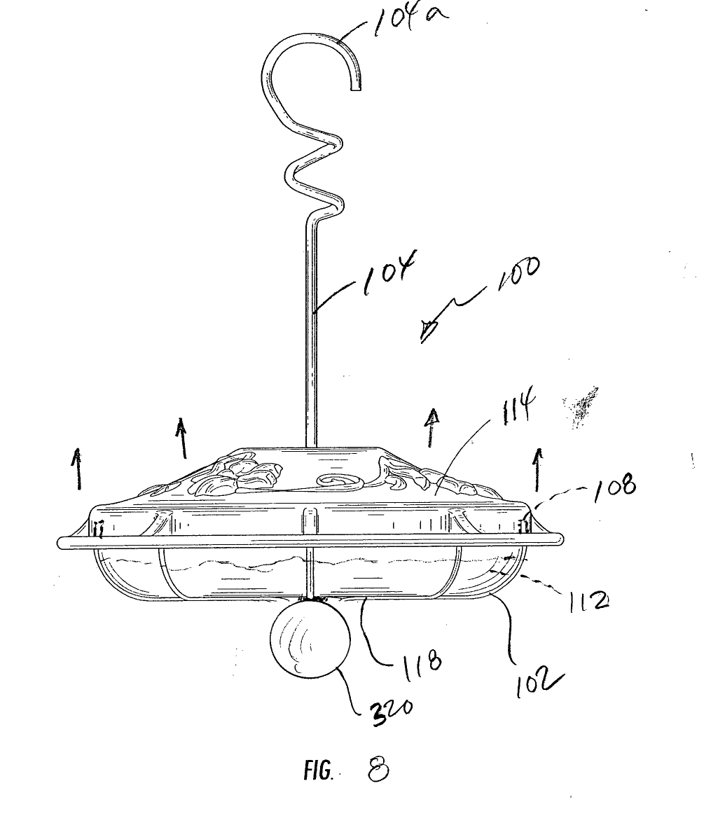

FIG. 8 shows a feeder 100 that is equipped with a stabilization member 320 that is in the shape of a sphere. Again, the weighting provided below the feeder adds stabilization yet provides an attractive appearance to the feeder 100.

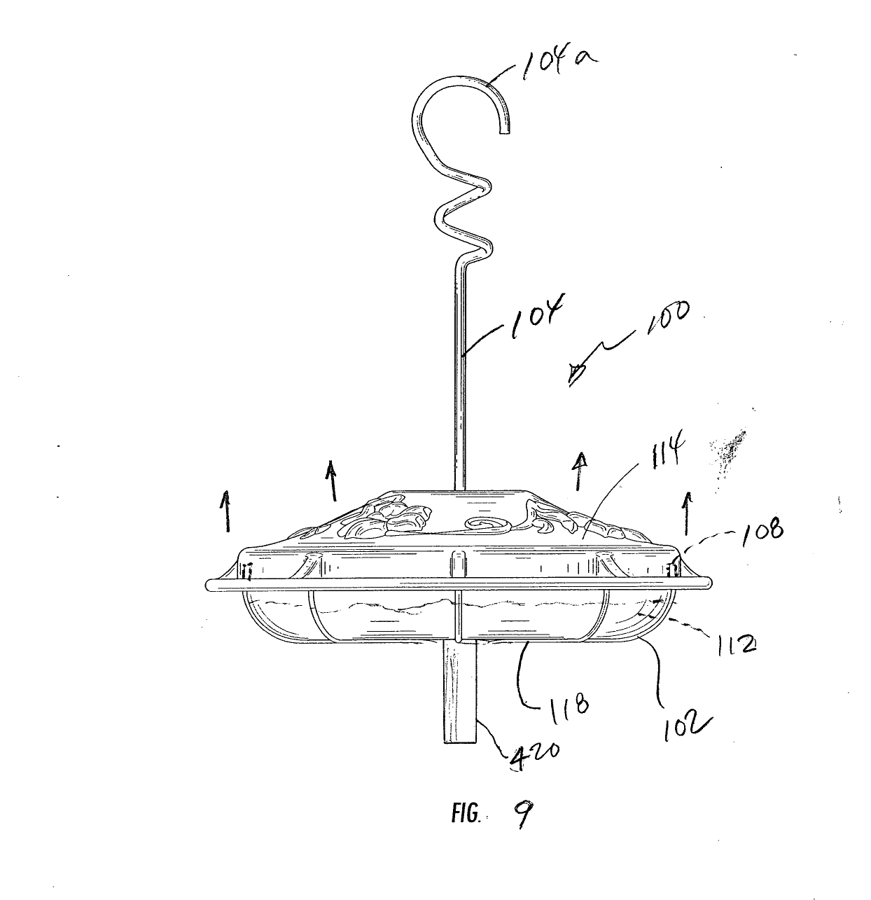

Still further, FIG. 9 shows an elongated stabilization member 420 in the form of a elongated rod. In this case, the elongation of the stabilization member 420 further lowers the center of gravity well below the bottom surface 118 of the base 102 to require even more lateral force to cause the feeder 100 to move about and disruption of the nectar 112 inside. The cross-section and size of the elongated stabilization member 420 can be adjusted to suit the size and configuration of the feeder 100 at hand.

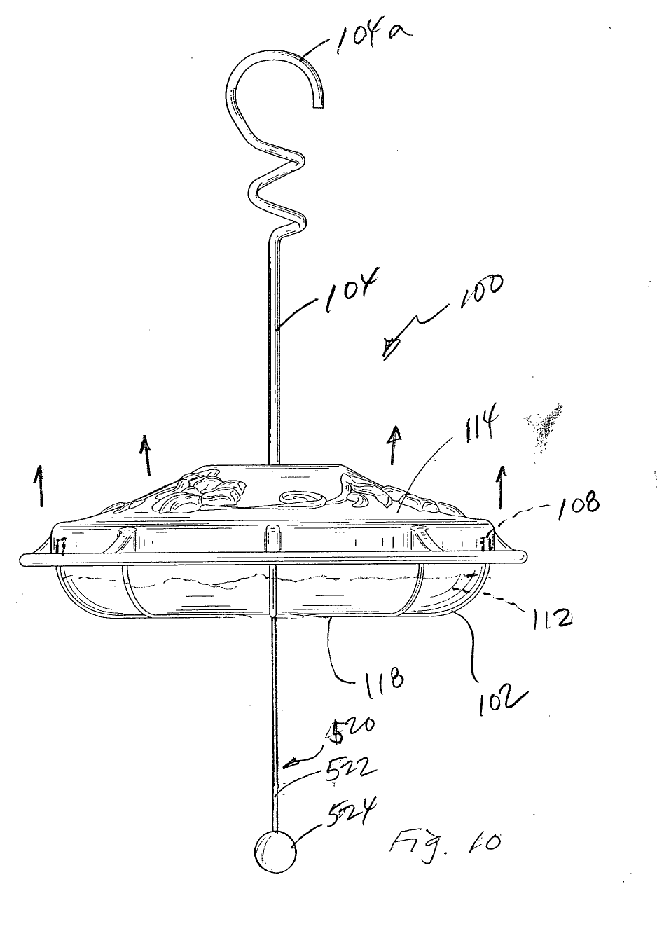

Referring now to FIG. 10, yet another alternative embodiment of the present invention is shown. In this embodiment, the feeder 100 is equipped with a stabilization member, generally referred to as 520, that depends far below the bottom surface 118 of the base 102 of the feeder 100. The stabilization member 520 includes a long downwardly depending member 522 which could be wire, string or a rigid or flexible rod that terminates with a weighting member 524 connected thereto. The weighting member 524 is shown as spherical but it could be of any aesthetic configuration. Thus, the center of gravity of the feeder 100 is effectively lowered well below the bottom surface 118 of the base of the feeder to stabilize it.

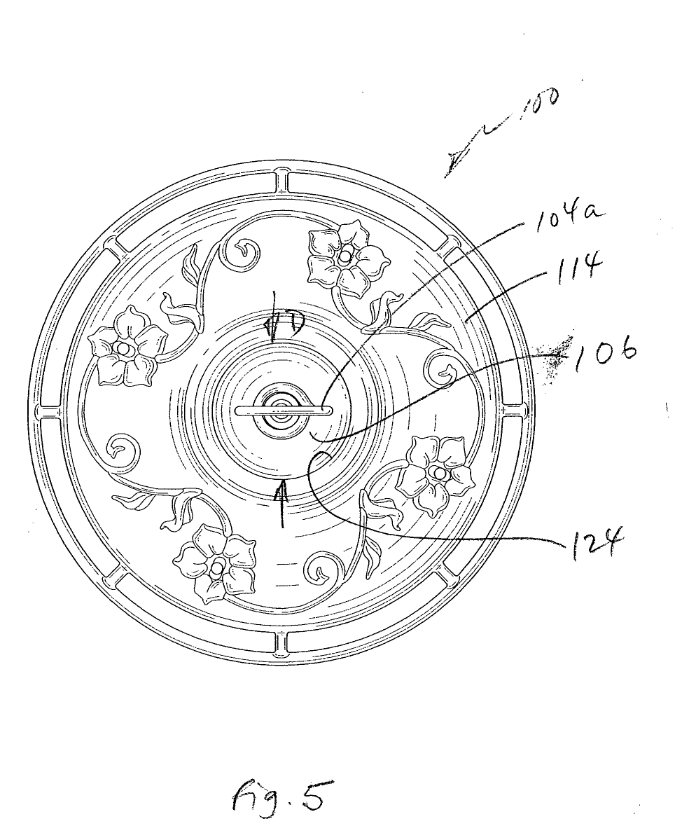

The stabilization members 120, 220, 320, 420 and 520 of the respective embodiments can also help stabilize the feeder during filling thereof. As shown in FIGS. 2-6, the cover 114 is separated from the base 102. The cover 102 can be routed over the hanger 104 if the hanger 104 is optionally left attached to the center portion 106 of the base 102. The hanger 104 includes a hook portion 104a for attachment to a tree, post or the like, as referred to as 105 in FIG. 4. As can be seen in FIG. 5, the width of the hanger 104, which is largest at its hook 104a, is less than the diameter D of the aperture 124 in the cover 114 to permit the cover 114 to be easily removed without first detaching the hanger 104. However, the hanger 104 may be detached first, if desired. For example, the hanger 104 may be threadably connected to the center portion 106 of the base 102.

After the cover 114 is removed from the base 102, the feeder 100 may be left hanging from support 105 with the cover 114 routed upwardly over the support 105. The empty base 102 with nectar trough 110 is now exposed so that nectar can be poured therein. During the pouring process, the respective stabilization member 120, 220, 320, 420 or 520 assists in keeping the base stable during the filling process as it keeps the entire feeder more stable during use and feeding.

The feeder 100 of the present invention can have many different types of configurations with different types of stabilizing members 120. The feeder 100 itself is typically made of plastic but can be made of virtually any type of material. Further, the annular-shaped feeder 100 discussed herein is just one example of many configurations of feeders that can be accommodated by the method of filling of the present invention. For example, the center aperture 124 through the cover may be square instead of round. Also, the downwardly depending member 120 may be integrated into the molding of the base 102 or attached as a separate member.

In general, the feeder 100 of the present invention includes an additional weighting member that acts as a stabilization member 120, 220, 320, 420 and 520 during filling and use of the feeder. As a result, the feeder 100 is more stable than prior art basin nectar feeders.

It would be appreciated by those skilled in the art that various changes and modifications can be made to the illustrated embodiments without departing from the spirit of the present invention. All such modifications and changes are intended to be covered by the appended claims.

What is claimed is:

1. A nectar bird feeder, comprising:
a base, having a bottom surface and a reservoir for containing nectar therein;
a stabilizing member downwardly depending from the bottom surface of the base; and
a cover releasably attached to the base.

2. The feeder of claim 1, wherein the cover is releasably attached to the base by a friction fit.

3. The feeder of claim 1, wherein the stabilizing member has a free end that is positioned a selected distance from the bottom surface of the base.

4. The feeder of claim 1, further comprising:
ornamental decoration disposed on the stabilizing member.

5. The feeder of claim 1, further comprising:
a hanger connected to the base and extending upwardly therefrom.

6. The feeder of claim 5, wherein the hanger is removably connected to the base.

7. The feeder of claim 1, wherein the stabilizing member is made of a material selected from the group consisting of brass, aluminum and steel.

8. The feeder of claim 1, wherein the stabilizing member is in the shape of a rod.

9. The feeder of claim 1, wherein the stabilizing member is in the shape of a sphere.

10. A nectar bird feeder with improved stabilization, comprising:
a base, having a bottom surface, a central portion, and a trough-shaped reservoir positioned about the central portion for containing nectar therein;
a hanger connected to the central portion of the base and extending upwardly therefrom;
an extension stabilizing member downwardly depending from the bottom surface of the base; and
an annular-shaped cover, having a top surface and lower edges, that is releasably attached to the base and co-extensive with the trough of the base with an aperture therein;
wherein the center of gravity of the feeder is positioned below the bottom surface of the base for improved stabilization thereof.

11. The feeder of claim 10, wherein the cover is releasably attached to the base by a friction fit.

12. The feeder of claim 10, further comprising:
ornamental decoration disposed on the stabilizing member.

13. The method of claim 10, wherein the hanger is removably connected to the base.

14. The feeder of claim 10, wherein the stabilizing member is made of a material selected from the group consisting of brass, aluminum and steel.

15. The feeder of claim 10, wherein the stabilizing member is in the shape of a rod.

16. The feeder of claim 10, wherein the stabilizing member is in the shape of a sphere.
